(19) United States
(12) Patent Application Publication
(10) Pub. No.: US 2026/0143570 A1
(43) Pub. Date: May 21, 2026

(54) LIGHT EMITTING DIODE MATRIX AND METHOD FOR CONTROLLING SAME

(71) Applicant: Y.E. Hub Armenia LLC, Yerevan (AM)

(72) Inventor: Dmitrii VLASOV, Moscow (RU)

(21) Appl. No.: 19/362,395

(22) Filed: Oct. 18, 2025

(30) Foreign Application Priority Data
Nov. 15, 2024 (RU) 2024134252

(51) Int. Cl. H05B 45/14

(52) U.S. Cl. CPC H05B 45/14

(57) ABSTRACT

A light emitting diode (LED) matrix and a method for controlling same. The matrix an array of LEDs and an LED matrix control circuit. The control circuit includes a driver corresponding to each LED; a voltage controller; a digital-to-analog converter (DAC); a microcontroller unit (MCU); and a current-to-voltage converter. The method is executed by the control circuit. The method includes generating, by the MCU, a digital control signal indicative of a brightness level to be set in a given LED; generating, by the DAC, an analogue control signal for the given LED based on the digital control signal; acquiring, by the voltage controller, the analogue control signal and a feedback signal; generating, by the voltage controller, a synthesized control signal based on the analogue control signal and the feedback signal; and adjusting, by the corresponding driver, a brightness level of the given LED.

### CROSS-REFERENCE

The present application claims priority to Russian Patent Application No. 2024134252, entitled “Light Emitting Diode Matrix and Method for Controlling Same”, filed November 15, 2024, the entirety of which is incorporated herein by reference.

### TECHNICAL FIELD

The present technology relates generally to light emitting diode (LED) matrix systems and methods for controlling LED matrices.

### BACKGROUND

Large, illuminated image screen solutions, such as those used in television sets and digital light processing (DLP) projectors, often rely on light emitting diode (LED) based technology. There remain technological challenges in implementing large solutions, especially in large LED arrays having thousands diodes.

LED-based screens may be operated with AC or DC power circuits. DC-based LED systems are relatively more energy-efficient and less expensive than similarly sized AC-based systems. DC systems require pulse-width modulation components (PWM) for the load switching on individual LEDs. This leads to light pulsation in DC-based LED systems, however, which can result in visual discomfort for users.

Use of an AC-powered, constant voltage LED matrix circuit permits a more comfortable viewing experience, as there is less flickering and pulsation than in DC-based systems. AC-powered LED systems also require lower current values for the diodes. Lower current in turn can lead to longer LED life cycles by reducing wear on the diodes.

Unfortunately, while there are several advantages to using an AC-power regime for operating an LED system, there is generally required a more complicated operating and control architecture to control the diodes. Each diode must be individually and precisely controlled, requiring specific and often complex voltage driving electronics schemes. It is thus often the case that a comparatively complicated operating logic is required for precise voltage control for each of the diodes of the LED matrix when using an AC-power regime.

There thus remains a desire for improved LED-based screen systems to address at least some of the above disadvantages.

### SUMMARY

Developers have devised devices and methods for overcoming at least some drawbacks present in prior art solutions.

In some embodiments of the present technology, the developers of the present technology have developed a specific electrical architecture enabling more precise LED control for forming a final display image of a higher quality based on constant current mode operation, which removes the pulsation effects of standard DC-operation. In accordance with at least some of the non-limiting embodiments of the present technology, the system includes an individual driver for each LED of an LED array. Using the corresponding driver, each LED in the matrix is provided with an individual current level based on the driver signal using a transistor. Additionally, each LED is coupled with memory, specifically with the transistor being coupled with a respective capacitor. The current level supplied to the LED is determined by the voltage applied to the transistor. The capacitor provides a memory function as the capacitor maintains the voltage level during each frame of operation, which corresponds to a light level “programmed” into the driver.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

According to one non-limiting implementation of the present technology, there is provided a light emitting diode (LED) matrix. The matrix includes an array of light emitting diodes (LEDs) and an LED matrix control circuit operatively connected to the array of LEDs. The LED matrix control circuit includes a plurality of drivers, each driver of the plurality of drivers being coupled to a corresponding LED of the array of LEDs; a voltage controller operatively connected to the plurality of drivers; a digital-to-analog converter (DAC) operatively connected to the voltage controller; a microcontroller unit (MCU) operatively connected to the plurality of drivers via the DAC and the voltage controller; and a current-to-voltage converter operatively connected between the plurality of drivers and the voltage controller.

In some implementations, each driver of the plurality of drivers includes a current source component assembly; and a memory component coupled to the current source component assembly.

In some implementations, each driver of the plurality of drivers includes a transistor; and a capacitor coupled to the transistor.

In some implementations, the LED matrix control circuit is configured to: generate, by the MCU, a digital control signal for a given LED of the array of LEDs to the DAC, the digital control signal being indicative of a brightness level to be set in the given LED; generate, by the DAC, an analogue control signal for the given LED, the analogue control signal being generated based on the digital control signal; acquire, by the voltage controller: the analogue control signal, and a feedback signal from the current-to-voltage converter; generate, by the voltage controller, a synthesized control signal based on the analogue control signal and the feedback signal, a corresponding driver of the given LED charging based on the synthesized control signal; and adjust, by the corresponding driver, a brightness level of the given LED based on said charging.

In some implementations, the LED matrix control circuit is configured to: charge the corresponding driver of the given LED during a programming stage of a given frame of LED matrix operation; and adjust the brightness level of the given LED during a glow stage of the given frame of LED matrix operation.

In some implementations, the programming stage occupies about 30% of each frame of LED matrix operation; and the glow stage occupies about 70% of each frame of LED matrix operation.

In some implementations, the current-to-voltage converter is configured to produce the feedback signal based on a detected present current level of the corresponding driver of the given LED.

In some implementations, the voltage controller is configured to drive the array of LEDs in a constant voltage (AC) operation.

In some implementations, the LED matrix control circuit is configured to control the array of LEDs using an AC-powered, constant voltage operation.

In some implementations, the LED matrix control circuit is configured to control the array of LEDs in a 120 frames-per-second (FPS) operation with 256 brightness levels (8 bit).

In some implementations, the LED matrix control circuit is configured to: charge a corresponding driver of a given LED during a programming stage of a given frame of LED matrix operation, the programming stage occupying about 30% of each frame of LED matrix operation; and adjust a brightness level of the given LED during a glow stage of the given frame of LED matrix operation, the glow stage occupying about 70% of each frame of LED matrix operation.

According to another non-limiting implementation of the present technology, there is provided a method for controlling a light emitting diode (LED) matrix, the method being executed by an LED matrix control circuit operatively connected to an array of light emitting diodes (LEDs), the LED matrix control circuit including a plurality of drivers, each driver of the plurality of drivers being coupled to a corresponding LED of the array of LEDs. The method includes generating, by a microcontroller unit (MCU) of the LED matrix control circuit, a digital control signal, the digital control signal being indicative of a brightness level to be set in a given LED of the array of LEDs; generating, by a digital-to-analogue converter (DAC) of the LED matrix control circuit, an analogue control signal for the given LED, the analogue control signal being generated based on the digital control signal; acquiring, by a voltage controller of the LED matrix control circuit: the analogue control signal, and a feedback signal from a current-to-voltage converter of the LED matrix control circuit; generating, by the voltage controller, a synthesized control signal based on the analogue control signal and the feedback signal, a corresponding driver of the given LED charging based on the synthesized control signal; and adjusting, by the corresponding driver, a brightness level of the given LED based on said charging.

In some implementations, adjusting the brightness level of the given LED comprises controlling the brightness level by a transistor of the corresponding driver; and charging of the corresponding driver includes charging a capacitor coupled to the transistor.

In some implementations, charging the corresponding driver comprises charging the corresponding driver of the given LED during a programming stage of a given frame of LED matrix operation; and adjusting the brightness level comprising adjusting the brightness level of the given LED during a glow stage of the given frame of LED matrix operation.

In some implementations, the programming stage occupies about 30% of each frame of LED matrix operation; and the glow stage occupies about 70% of each frame of LED matrix operation.

In some implementations, the method further includes determining, by the current-to-voltage converter, the feedback signal based on a detected present current level of the corresponding driver of the given LED.

In some implementations, generating the synthesized control signal comprises generating the synthesized control signal, by the voltage controller, to drive the array of LEDs in a constant voltage (AC) operation.

In some implementations, generating, by the MCU, the digital control signal for the given LED comprises generating a plurality of digital control signals to control the array of LEDs in a 120 frames-per-second (FPS) operation with 256 brightness levels (8 bit).

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “microcontroller unit”, “controller” or “processor”, may be provided through the use of dedicated hardware as well as hardware capable of executing software in association with appropriate software. When provided by a processor or microprocessor, the functions may be provided by a single dedicated processor, by a single shared processor, or by a plurality of individual processors, some of which may be shared. Moreover, explicit use of the term “microcontroller”, “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Implementations of the present technology each have at least one of the above-mentioned objects and/or aspects, but do not necessarily have all of them. It should be understood that some aspects of the present technology that have resulted from attempting to attain the above- mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 schematically depicts a light emitting diode (LED) matrix according to a non-limiting embodiment of the present technology;

FIG. 2 illustrates another schematic diagram of the LED matrix of FIG. 1;

FIG. 3 illustrates an LED and driver pairing of the LED matrix of FIG. 1; and

FIG. 4 depicts a flowchart illustrating an example method for controlling a light emitting diode (LED) matrix in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity. With these fundamentals in place, we will now consider some non-limiting examples to illustrate various implementations of aspects of the present technology.

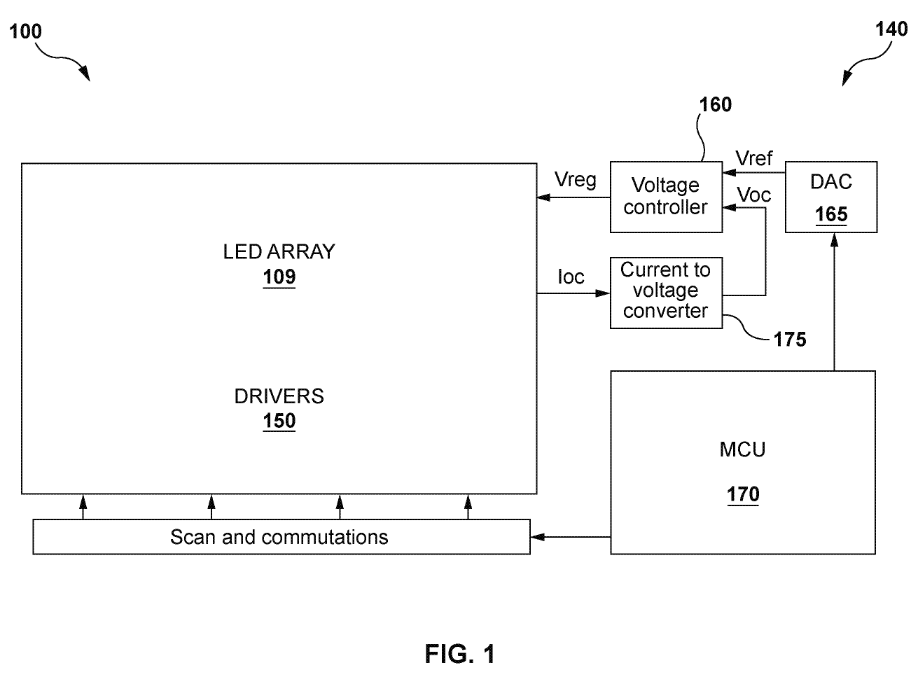

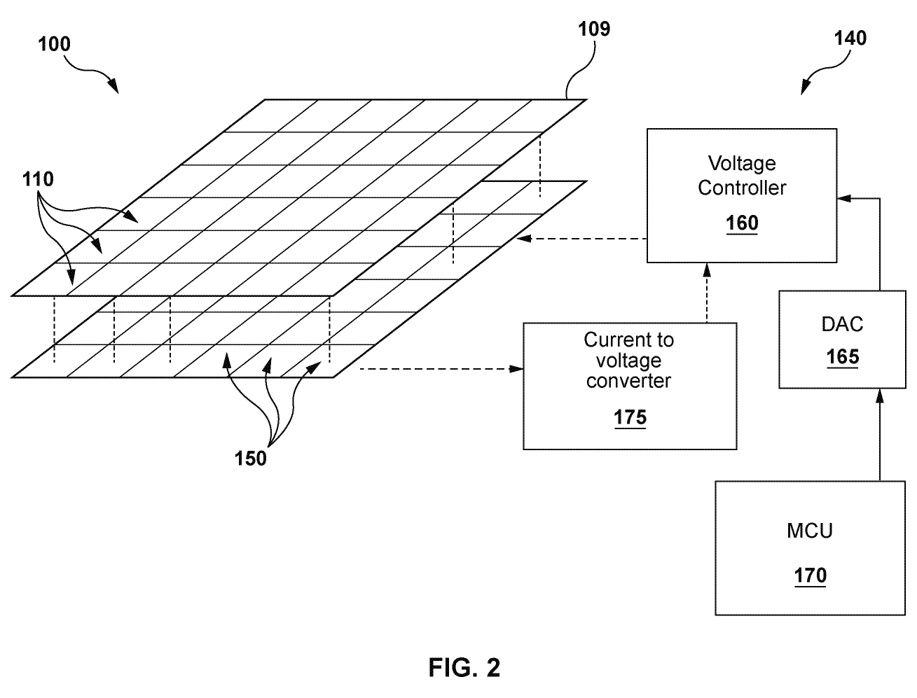

With reference to FIGS. 1 and 2, there is depicted a light emitting diode (LED) matrix 100 according to one non-limiting embodiment of the present technology. The LED matrix 100, also referred to herein as the matrix 100, could be implemented in a variety of devices having illuminated screens. These devices could include, but are not limited to, televisions and digital light processing (DLP) projectors.

The LED matrix 100 includes an array 109 of light emitting diodes (LEDs) 110. The presently discussed technology is specifically geared to LED matrices having 2 to 6 thousand LEDs 110, but the exact number of LEDs is not meant to be especially limited. The matrix size is simply one possible embodiment to which the present technology could be applied. It is further contemplated that the total number of LEDs is generally controlled in subgroups according to the methods described herein, for instance in blocks of 250 to 500 LEDs. Depending on the total number of LEDs, a plurality of blocks of a predetermined number of LEDs can be programmed for more efficient control. The number of blocks/number of LEDs per block of control may also depend on a frame rate or total panel size.

It is also noted that the LED array 109 is illustrated as a flat, rectangular array, but the particular shape and form is not meant to be limited. It is also noted that the type and technology of the LEDs 110 utilized in the present technology is determined for the particular implementation, and not meant to be specifically limited by the present.

By the present technology, the LED matrix 100 includes an LED matrix control circuit 140 to provide individual control of the LEDS 110. The LED matrix control circuit 140 is operatively and communicatively connected to the LEDs 110.

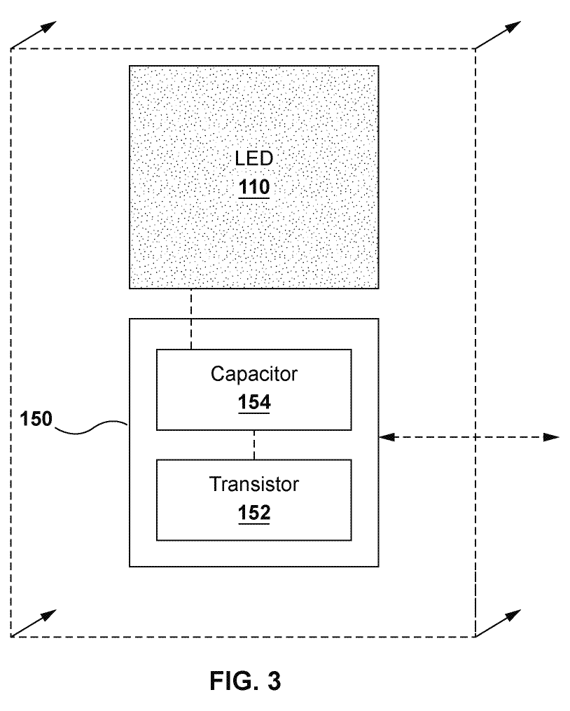

The LED matrix control circuit 140 includes a plurality of drivers 150. With additional reference to FIG. 3, there is specifically one driver 150 paired with each LED 110. By the present technology, a “driver” simply designates an electronic component having a simple logic operation. Each driver 150 includes a current source component assembly and a memory component for controlling the corresponding LED 110. By the present technology, each driver 150, specifically the current source component assembly, thus includes a transistor 152 for providing at least part of a simple logic control of the LED 110. Each driver 150 also includes a corresponding capacitor 154 coupled to the transistor 152. During operation, the current level supplied to the LED 110 is determined by the voltage applied to the transistor 152. The capacitor 154 provides a memory function as the capacitor 154 maintains the voltage level during each frame of operation of the matrix 100. Operation of the matrix 100 will be described in more detail below.

In the illustrated embodiment, the drivers 150 are disposed in an array in parallel with the LED array 109. It is contemplated that the drivers 150 could be spaced from the LEDs 100 or in a variety of configurations, so long as each driver 150 is coupled to its corresponding LED 110 in the array 109.

The LED matrix control circuit 140 includes a microcontroller unit (MCU) 170 operatively connected to the drivers 150. The MCU 170 is receives or retrieves information indicative of the brightness level required for each LED 110 during each frame of operation of the LED matrix 100. Depending on the implementation, the MCU 170 could be connected to a memory storing frame by frame illumination information. It is also contemplated that the LED matrix control circuit 140 could include a memory dedicated to image creation information in some implementations.

The MCU 170 is a single integrated processing circuit which acts as the “brain” or a central processor for the matrix 100. Depending on the implementation, the MCU 170 may be implemented by a conventional microprocessor or microcontroller. It is also contemplated that in some implementations, the MCU 170 may be implemented by another generic computer system of the device in which the matrix operates or distributed amongst multiple systems. The MCU 170 may also be specifically dedicated to the implementation of the present technology. As a person in the art of the present technology may appreciate, multiple variations as to how the MCU 170 could be implemented may be envisioned without departing from the scope of the present technology.

The LED matrix control circuit 140 also includes a voltage controller 160 operatively connected to the drivers 150. Also referred to as voltage regulator, the voltage controller 160 is a feedback-based control loop mechanism used to manage, control and automatically adjust voltage output. In the present technology, the voltage controller 160 delivers a variable voltage to the capacitor 154, based on desired brightness of the LED 110 (described in more detail below). The voltage controller 160 generates a synthesized control signal, described below, to drive the array 109 of LEDs 110 in a constant current operation.

The LED matrix control circuit 140 also includes a digital-to-analog converter (DAC) 165 operatively connected to the voltage controller 160. The MCU 170 is operatively connected to the drivers 150 via the DAC 165 and the voltage controller 160. The DAC 165 has 256 possible output currents depending on the programmed or intended brightness of a given LED 110. The LED matrix control circuit 140 thus is capable of producing an 8-bit image with the LEDs 110.

The LED matrix control circuit 140 further includes a current-to-voltage converter 175 operatively connected between the drivers 150 and the voltage controller 160. The current-to-voltage converter 175 is an electronic component assembly that produces a voltage proportional to a current supplied thereto. As is described further below, the current-to-voltage converter 160 is configured to produce a feedback signal, to be supplied to the voltage controller 160, based on a detected present current level of one of the drivers 150.

Operation of the LED matrix 100 generally proceeds as follows; the operation for one particular LED 110 will be described but the same process will generally be performed for each LED 110 in parallel.

During a programming stage, the MCU 170 generates a digital control signal indicative of the programmed or desired brightness level for a given LED 110. The DAC 165 receives the digital control signal and converts it into an analog signal.

As is illustrated in FIG. 1, the DAC 165 specifically generates a reference voltage signal (Vref) based on the digital signal from the MCU 170. The voltage signal magnitude is proportional to the programmed or desired brightness of given LED 110. In at least some implementations, the reference voltage signal is greater for brighter LED implementation.

Concurrently, the current-to-voltage converter 175 determines a feedback signal, Voc, based on the forward current level Ioc of the given LED 110. The feedback signal provides an indication of the present current level of the driver of selected LED 110 (programming stage).

The voltage controller 160 subsequently compares the reference voltage signal Vref and the feedback signal Voc. Based on the signals Vref and Voc, the voltage controller 160 adjusts an output signal Vreg until the Vref and Voc voltages are equal. When the signals are equal, the capacitor 154 has been charged to produce an Ioc current equal to the current value programmed by the MCU 170.

At this point, the programming stage completes, and a glow stage commences. All of the LEDs 110 in the array 109 then turn on simultaneously, with their current values set to match the programmed brightness. In the illustrated implementation, the programming stage occupies about 30% of each frame of operation and the glow stage occupies about 70% of each frame of operation.

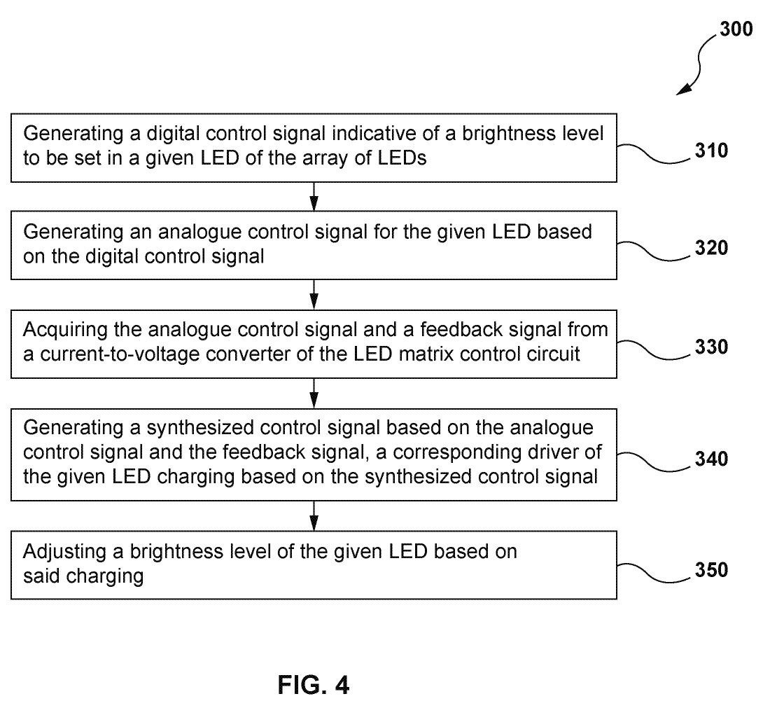

With reference to FIG. 4, a method 300 for controlling the LED matrix 100 by the LED matrix control circuit 140 is illustrated. Steps of the method 300 are described for the control of one particular LED 110 of the array 109. During operation of the matrix 100, the method 300 will generally be carried out for every or nearly every LED 110 of the array 109. It is further noted that the method steps set out below cover operation of the given LED 110 over one frame; the method 300 is then repeated for every frame of operation.

### STEP 310: Generating a digital control signal indicative of a brightness level to be set in a given LED of the array of LEDs

The method 300 begins, at step 310, with generating a digital control signal for the given LED 110 of the LED array 109 by the MCU 170. The digital control signal is generated to be indicative of a brightness level to be set in the particular or given LED 110. The MCU 170 and the circuit 140 generally is arranged and configured to operate with 256 brightness levels, and thus generates an 8 bit digital signal.

### STEP 320: Generating an analogue control signal for the given LED, the analogue control signal being generated based on the digital control signal

The method 300 continues, at step 320, with generating an analogue control signal for the given LED 110. The analogue control signal is generated by the DAC 165 based on the digital control signal from the MCU 170.

### STEP 330: Acquiring the analogue control signal and a feedback signal

The method 300 proceeds to step 330 with acquiring, by the voltage controller 160, the analogue control signal from the DAC 165 and a feedback signal from the current-to-voltage converter 175. The current-to-voltage converter 175 determines the feedback signal based on a detected present current level of the corresponding driver 150 of the given LED 110.

### STEP 340: Generating a synthesized control signal based on the analogue control signal and the feedback signal

The method 300 proceeds, at step 340, with generating, by the voltage controller 160, the synthesized control signal based on the analogue control signal and the feedback signal.

### STEP 350: Adjusting a brightness level of the given LED

The method 300 proceeds, at step 340, with adjusting a brightness level of the given LED 110 based on said charging by the corresponding driver 150, specifically based on the synthesized control signal.

In the present implementation, adjusting the brightness level of the given LED 110 includes controlling the brightness level by the transistor 152 and charging of the corresponding driver 150 includes charging the capacitor 154.

Charging the corresponding driver 150, specifically the capacitor 154, is performed during a programming stage of each frame of operation of the LED matrix 100. Adjusting the brightness level, by the transistor 152 providing current to the LED 110, is performed during a glow stage of each frame of operation of the LED matrix 100. In at least some implementations, the programming stage occupies about 30% of each frame of LED matrix operation and the glow stage occupies about 70% of each frame of LED matrix operation.

As is noted above, during full operation of the LED matrix 100, the method 300 will further include generating, by the MCU 170, a plurality of digital control signals to control each or nearly each LEDs 110 of the matrix 100 in a 120 frames-per-second (FPS) operation with 256 brightness levels (8 bit). The particular frame rate (FPS) and brightness levels available are simply one example implementation, and other rates of operation and available brightness levels are contemplated.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that some of these steps may be combined, sub-divided, or re-ordered without departing from the teachings of the present technology. Accordingly, the order and grouping of the steps is not a limitation of the present technology.

1. A light emitting diode (LED) matrix comprising:
an array of light emitting diodes (LEDs); and
an LED matrix control circuit operatively connected to the array of LEDs, the LED matrix control circuit comprising:
a plurality of drivers, each driver of the plurality of drivers being coupled to a corresponding LED of the array of LEDs;
a voltage controller operatively connected to the plurality of drivers;
a digital-to-analog converter (DAC) operatively connected to the voltage controller;
a microcontroller unit (MCU) operatively connected to the plurality of drivers via the DAC and the voltage controller; and
a current-to-voltage converter operatively connected between the plurality of drivers and the voltage controller.

2. The LED matrix of claim 1, wherein each driver of the plurality of drivers comprises:
a current source component assembly; and
a memory component coupled to the current source component assembly.

3. The LED matrix of claim 1, wherein each driver of the plurality of drivers comprises:
a transistor; and
a capacitor coupled to the transistor.

4. The LED matrix of claim 1, wherein the LED matrix control circuit is configured to:
generate, by the MCU, a digital control signal for a given LED of the array of LEDs to the DAC, the digital control signal being indicative of a brightness level to be set in the given LED;
generate, by the DAC, an analogue control signal for the given LED, the analogue control signal being generated based on the digital control signal;
acquire, by the voltage controller:
the analogue control signal, and
a feedback signal from the current-to-voltage converter;
generate, by the voltage controller, a synthesized control signal based on the analogue control signal and the feedback signal, a corresponding driver of the given LED charging based on the synthesized control signal; and
adjust, by the corresponding driver, a brightness level of the given LED based on said charging.

5. The LED matrix of claim 4, wherein the LED matrix control circuit is configured to:
charge the corresponding driver of the given LED during a programming stage of a given frame of LED matrix operation; and
adjust the brightness level of the given LED during a glow stage of the given frame of LED matrix operation.

6. The LED matrix of claim 5, wherein:
the programming stage occupies about 30% of each frame of LED matrix operation; and
the glow stage occupies about 70% of each frame of LED matrix operation.

7. The LED matrix of claim 4, wherein the current-to-voltage converter is configured to produce the feedback signal based on a detected present current level of the corresponding driver of the given LED.

8. The LED matrix of claim 4, wherein the voltage controller is configured to drive the array of LEDs in a constant voltage (AC) operation.

9. The LED matrix of claim 1, wherein the LED matrix control circuit is configured to control the array of LEDs using an AC-powered, constant voltage operation.

10. The LED matrix of claim 1, wherein the LED matrix control circuit is configured to control the array of LEDs in a 120 frames-per-second (FPS) operation with 256 brightness levels (8 bit).

11. The LED matrix of claim 10, wherein the LED matrix control circuit is configured to:
charge a corresponding driver of a given LED during a programming stage of a given frame of LED matrix operation, the programming stage occupying about 30% of each frame of LED matrix operation; and
adjust a brightness level of the given LED during a glow stage of the given frame of LED matrix operation, the glow stage occupying about 70% of each frame of LED matrix operation.

12. A method for controlling a light emitting diode (LED) matrix, the method being executed by an LED matrix control circuit operatively connected to an array of light emitting diodes (LEDs), the LED matrix control circuit including a plurality of drivers, each driver of the plurality of drivers being coupled to a corresponding LED of the array of LEDs, the method comprising:
generating, by a microcontroller unit (MCU) of the LED matrix control circuit, a digital control signal, the digital control signal being indicative of a brightness level to be set in a given LED of the array of LEDs;
generating, by a digital-to-analogue converter (DAC) of the LED matrix control circuit, an analogue control signal for the given LED, the analogue control signal being generated based on the digital control signal;
acquiring, by a voltage controller of the LED matrix control circuit:
the analogue control signal, and
a feedback signal from a current-to-voltage converter of the LED matrix control circuit;
generating, by the voltage controller, a synthesized control signal based on the analogue control signal and the feedback signal, a corresponding driver of the given LED charging based on the synthesized control signal; and
adjusting, by the corresponding driver, a brightness level of the given LED based on said charging.

13. The method of claim 12, wherein:
adjusting the brightness level of the given LED comprises controlling the brightness level by a transistor of the corresponding driver; and
charging of the corresponding driver includes charging a capacitor coupled to the transistor.

14. The method of claim 12, wherein:
charging the corresponding driver comprises charging the corresponding driver of the given LED during a programming stage of a given frame of LED matrix operation; and
adjusting the brightness level comprising adjusting the brightness level of the given LED during a glow stage of the given frame of LED matrix operation.

15. The method of claim 14, wherein:
the programming stage occupies about 30% of each frame of LED matrix operation; and
the glow stage occupies about 70% of each frame of LED matrix operation.

16. The method of claim 12, further comprising:
determining, by the current-to-voltage converter, the feedback signal based on a detected present current level of the corresponding driver of the given LED.

17. The method of claim 12, wherein:
generating the synthesized control signal comprises generating the synthesized control signal, by the voltage controller, to drive the array of LEDs in a constant voltage (AC) operation.

18. The method of claim 12 , wherein generating, by the MCU, the digital control signal for the given LED comprises generating a plurality of digital control signals to control the array of LEDs in a 120 frames-per-second (FPS) operation with 256 brightness levels (8 bit).
